(19) United States
(12) Patent Application Publication
(10) Pub. No.: US 2017/0080497 A1
(43) Pub. Date: Mar. 23, 2017

(54) Infiltrated Segregated Ferrous Materials

(71) Applicant: The NanoSteel Company, Inc., Providence, RI (US)

(72) Inventors: Charles D. TUFFILE, Dighton, MA (US); Harald LEMKE, Northport, NY (US); Patrick E. MACK, Milford, MA (US)

(21) Appl. No.: 15/270,834

(22) Filed: Sep. 20, 2016

Related U.S. Application Data
(60) Provisional application No. 62/221,445, filed on Sep. 21, 2015.
(60) Provisional application No. 62/252,867, filed on Nov. 9, 2015.

(51) Int. Cl. B22F 3/26; B22F 3/10; C22C 38/58; C22C 38/54; C22C 38/34; B33Y 80/00; C22C 38/02; B22F 7/08; B22F 7/00; B33Y 10/00; B33Y 40/00; B33Y 70/00; B22F 1/00; C22C 38/04

(52) U.S. Cl. CPC B22F 3/26; B22F 1/0059; B22F 3/1021; C22C 38/58; C22C 38/54; C22C 38/34; C22C 38/04; C22C 38/02; B22F 1/0048; B22F 7/08; B22F 7/008; B33Y 10/00; B33Y 40/00; B33Y 70/00; B33Y 80/00; B22F 2302/45; B22F 2998/10; B22F 2304/15

(57) ABSTRACT

Layer-by-layer construction of metallic alloys preferably via binder jetting followed by sintering and binder removal to form a porous metallic skeleton which then may be infiltrated with an infiltrant to provide a free-standing metallic part. The part indicates a volume loss of less than or equal to 200 mm³ as measured by ASTM G65-10 Procedure A (2010) and an un-notched impact toughness of greater than or equal to 55 J according to ASTM E21-12 (2012).

### CROSS REFERENCE TO RELATED APPLICATIONS

This application claims the benefit of U.S. Provisional Application Ser. No. 62/221,445 filed Sep. 21, 2015 and U.S. Provisional Application Ser. No. 62/252,867 filed Nov. 9, 2015.

### FIELD OF THE INVENTION

The present invention relates to alloys and methods for the preparation of free-standing metallic materials in a layerwise manner.

### BACKGROUND

Many applications, such as those found in tooling, dies, molds, drilling, pumping, agriculture, and mining, require parts with high wear resistance to increase the durability and life expectancy of the parts before they must be changed or refurbished. Materials have been designed to provide high wear resistance to parts by either providing a bulk material with high wear resistance, or providing a composite material consisting of a low wear resistance matrix containing high wear resistance particles throughout the matrix. Many of these materials require a hardening heat treatment such as a quench and temper treatment to obtain the structures that provide wear resistance. While the hardening treatments are effective in increasing the wear resistance of the materials, they can have a deleterious effect on the dimensional control and integrity of parts subjected to the hardening treatment due to part distortions and cracking from thermally induced stresses.

Layerwise construction can be understood herein as a process where layers of a material are built up, or laid down, layer by layer to fabricate a component. Examples of layerwise construction include powder bed fusion with a laser or electron-beam energy source, directed energy deposition, binder jetting, sheet lamination, material extrusion, material jetting, and vat photopolymerization. The primary layerwise construction processes used with metal include powder bed fusion, directed energy deposition and binder jetting.

The binder jetting process is a layerwise construction process that has excellent capability to construct net shape parts by jetting (or printing) a binder onto a bed of powder, curing the binder, depositing a new layer of powder, and repeating. This process has been commercially used to produce parts from sand, ceramics, and various metals including Type 316 stainless steel and Type 420 stainless steel, hereinafter referred to by their UNS designations S31600 and S42000, respectively.

Due to the nature of the bed of powder in a solid-state binder jetting process, parts produced in this method inherently have significant porosity. After curing the printed binder, “green bonded” metal parts typically have porosity greater than or equal to 40%. Sintering of the green bonded parts increases the robustness of the parts by creating metallurgical bonds between the particles and also decreasing the porosity. Long sintering times can be used to reduce the porosity by more than 5%, however, this also results in part shrinkage and distortion of the parts, and can negatively affect the material structure. Therefore, the goal of sintering of green-bonded binder jet parts is to increase part strength by creating inter-particle metallurgical bonds but also minimize distortion and shrinkage by minimizing the reduction in porosity. Sintering shrinkage is typically in the 1-5% range for binder jet parts, with a similar reduction in porosity, which results in sintered parts with more than 35% porosity.

Porosity in sintered parts negatively affects the part's mechanical properties, thus it is desired to reduce the porosity of sintered parts. Infiltration, such as via capillary action, is a process used to reduce porosity by filling the voids in a sintered part with another material that is in a liquid phase. Part infiltration is used with sintered binder jet parts, as well as with many powder metallurgy processes and is thus well known. The primary issues that can be encountered with infiltration include poor wettability between the sintered skeleton and infiltrant leading to incomplete infiltration, material interactions between the sintered skeleton and the infiltrant such as dissolution erosion of the sintered skeleton and new phase formation, and internal stresses that can develop due to mismatched material properties.

Attempts at developing new material systems have been made for the binder jetting and infiltration process, however, due to the issues defined above, very few have been able to be commercialized. The two metal material systems that exist for binder jetting of industrial products are (1) S31600 infiltrated with 90-10 bronze, and (2) S42000 infiltrated with 90-10 bronze. The S31600 alloy has the following composition in weight percent: 16<Cr<18; 10<Ni<14; 2.0<Mo<3.0; Mn<2.0; Si<1.0; C<0.08, balance Fe. S31600 is not hardenable by a heat treatment, and it is relatively soft and is expected to have low wear resistance in the as-infiltrated condition as the wear resistance of this alloy produced via the laser powder bed fusion additive manufacturing process and measured via ASTM G65-04(2010) Procedure A is 342 mm³. Hence, bronze infiltrated S31600 is not a suitable material for high wear resistant parts. The S42000 alloy has the following composition in weight percent: 12<Cr<14; Mn<1.0; Si<1.0; C≧0.15, balance Fe. S42000 is hardenable via a quench and temper process, and is thus used as the wear resistant material for binder jet parts requiring wear resistance.

The process used for infiltrating binder-jet S42000 parts includes burying the parts in a particulate ceramic material that acts as a support structure to support the parts and resist part deformation during the sintering and infiltration processes. Encasing the binder-jet parts in the ceramic also facilitates homogenization of heat within the part, which reduces thermal gradients and potential for part distortion and cracking from the gradients. S42000 is dependent on a relatively high quench rate from the infiltration temperature to convert the austenitic structure to the martensitic structure that provides high hardness and wear resistance. S42000 is considered an air hardenable alloy, however, it is highly recommended that parts be quenched in oil to ensure that the cooling rate is sufficient throughout the part thickness to convert all austenite to martensite. When quenching from the 1120° C. infiltration temperature commonly used with 90-10 bronze (hereinafter referred to as Cu10Sn), oil quenching has a typical quench rate of greater than 20° C./sec, whereas the air quench rate is approximately 5° C./sec. The combination of the quenching capabilities of the infiltration furnace and ceramic layer around the binder-jet parts, which acts as a thermal barrier in quenching, severely limits the quench rate that is achievable for the parts and thus the hardness of the parts. The quench rate in a typical infiltrating furnace is approximately 0.01° C./sec, which would be the highest quench rate that parts infiltrated in such furnace would be exposed to, and they would likely experience a lower quench rate since the parts are buried in an insulating ceramic layer. Additionally, the austenizing temperature of S42000 is 1038° C., well above the solidus temperature (859° C.) of Cu10Sn, and above the liquidus temperature (1010° C.) as well. Hence, S42000 cannot be austenized and quenched in a separate step after infiltrating without melting the bronze infiltrant.

Hardenable steels such has precipitation-hardening (PH) and martensitic types suffer from similar thermally limiting restrictions as S42000, with S42000 being a martensitic grade. PH grades of steel such as 17-4PH and 15-5PH are dependent on a high quench rate from the austenization temperature to supersaturate elements into a solid solution. Insufficient quench rate in PH steels leads to segregation of secondary phases during cooling, and low-to-no supersaturation and driving force for precipitation during the aging process. Martensitic grades of steel such as types 420, 410, 440C stainless steel, and H13, 4340, and P20 tool steels, are dependent on a high quench rate from the austenizing temperature to drive the diffusionless austenite to martensite transformation. Insufficient quench rate in martensitic steel results in a high degree of retained austenite or a transformation to ferrite, both of which are deleterious to the wear resistance properties of the material.

Maraging steel is another type of hardenable steel, and unlike PH and martensitic grades, is able to be effectively hardened with the low cooling rates inherent in the infiltration process. The austenite to martensite transformation in maraging steel is independent of cooling rate and the precipitation of intermetallic phases in the aging process that enables high hardness occurs at a low enough temperature (480-510° C.) to largely avoid reactions with the infiltrant. Therefore, maraging steels could be used in binder jetting and infiltration to develop a high hardness steel skeleton infiltrated with a second material such as bronze. While the maraging steels develop high hardness in aging up to approximately 55 HRC, the wear resistance is relatively poor. When tested in the ASTM G65-10 Procedure A abrasion test, a laser powder bed fusion additively manufactured and heat treated specimen of the 18Ni (300) grade of maraging steel, hardened to 55 HRC, had a mass loss of 2.9 g and volume loss of 360 mm³. This wear resistance is similar to an annealed type 316L stainless steel which has a hardness of 95 HRB, mass loss of 2.87 g, and volume loss of 363 mm³.

It is therefore desired herein to produce net shaped parts via two approaches: (1) binder jetting, sintering to provide shrinkage of up to 5%, followed by an infiltration procedure and forming a free-standing part; or (2) binder jetting and sintering to reduce porosity at levels of greater than 5% and forming a free-standing metallic part after sintering. Each approach is contemplated to provide relatively high wear resistance and the parts can be used in applications requiring such characteristic.

### SUMMARY

Layer-by-layer construction is applied to alloys to produce a high wear resistant free-standing material. The wear resistance and impact toughness values of the materials are more than two times greater than those of the commercially available bronze infiltrated S42000 material produced using the layer-by-layer construction process of the present invention. For example, the wear resistance of the material results in a volume loss of less than or equal to 183 mm³ as measured by ASTM G65-10 Procedure A (2010) and the impact resistance of the material results in a toughness of greater than 58 J as measured per ASTM E23 (2012) on un-notched specimens. The structures that enable high wear resistance are preferably achieved in situ with the sintering and/or infiltration process and without the need for additional post-treating of the layer-by-layer build up with a thermal hardening process, such as by quenching and tempering or solutionizing and ageing. The layer-by-layer construction allows for the formation of metallic components that may be utilized in applications such as injection molding dies, molds, pumps, and bearings.

The method for layer-by-layer formation of a free-standing metallic part that relies upon a step of infiltration comprises: (a) supplying metal alloy particles comprising at least 50 weight % Fe and at least 0.5 weight % B and one or more elements selected from Cr, Ni, Si and Mn, wherein said particles have an initial level of boride phases; (b) mixing the metallic alloy particles with a binder wherein the binder bonds said particles and forms a layer of the free-standing metallic part wherein the layer has a porosity in the range of 20% to 60%; (c) heating the metallic alloy particles and the binder and forming a bond between the particles; (d) sintering the metallic alloy particles and the binder by heating at a temperature of greater than or equal to 800° C. and removing the binder and forming a porous metallic skeleton, which may have a porosity of 15% to 59.1%; (e) infiltrating the porous metallic skeleton with an infiltrant at a temperature of greater than or equal to 800° C. and cooling and forming the free-standing metallic part, wherein during said step of sintering and/or infiltrating, there is an increase in the level of boride phases. The free-standing metallic part indicates a volume loss of less than or equal to 200 mm³ as measured according to ASTM G65-10 Procedure A (2010) and an un-notched impact toughness of greater than or equal to 55 J according to ASTM E23-12 (2012).

The method for layer-by-layer formation of a free-standing metallic part that does not rely upon infiltration, comprises: (a) supplying metal alloy particles comprising at least 50 weight % Fe and at least 0.5 weight % B and one or more elements selected from Cr, Ni, Si and Mn, wherein the particles have an initial level of boride phases; (b) mixing the metallic alloy particles with a binder wherein the binder bonds the particles and forms a layer of said free-standing metallic part wherein said layer has a porosity in the range of 20% to 60%; (c) heating the metallic alloy particles and the binder and forming a bond between the particles; and (d) sintering the metallic alloy particles and the binder by heating at a temperature of greater than or equal to 800° C. and removing the binder and forming a porous metallic skeleton having a porosity of 0% to 55%, wherein during the step of sintering, one increases the level of boride phases.

### BRIEF DESCRIPTION OF THE DRAWINGS

FIG. 1 shows the microstructure of a ferrous alloy powder A3 of the present invention.

FIG. 2 shows the microstructure of a second ferrous alloy powder A4 of the present invention.

FIG. 3 shows the microstructure of a bronze infiltrated ferrous alloy A3 skeleton of the present invention.

FIG. 4 shows the microstructure of a bronze infiltrated second ferrous alloy skeleton A4 of the present invention.

FIG. 5 shows an EDS elemental map of a bronze infiltrated ferrous alloy of the present invention for elements (a) Fe, (b) Si, (c) Cr, (d) B, (e) O, and (f) Cu.

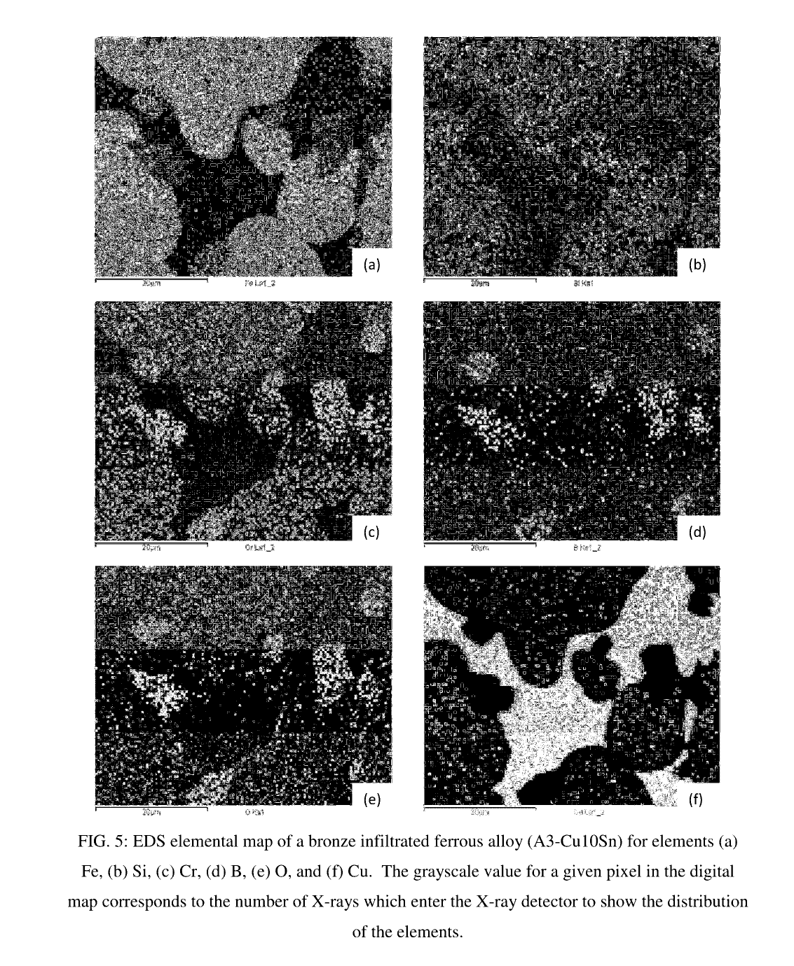

FIG. 6 shows an EDS elemental map of a bronze infiltrated second ferrous alloy of the present invention for elements (a) Fe, (b) Si, (c) Cr, (d) B, (e) O, and (f) Cu.

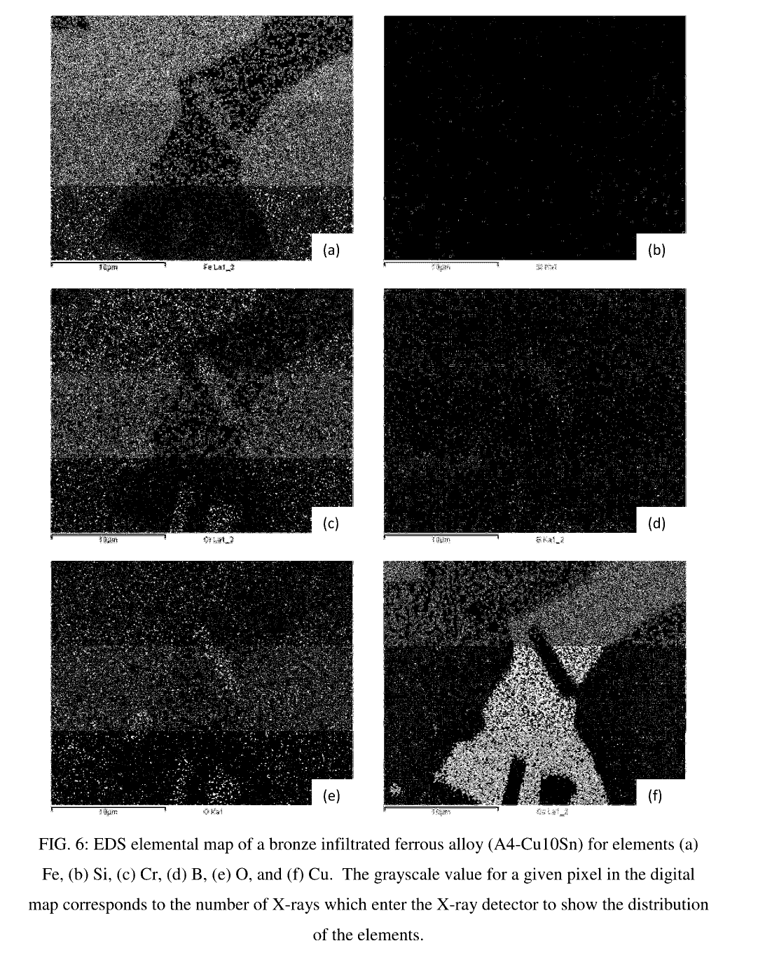

### DETAILED DESCRIPTION

The present invention relates to a method of constructing free-standing and relatively hard and wear-resistant iron-based metallic materials via a layer-by-layer build-up of successive metal layers followed by sintering and/or infiltration of the metallic structure. Reference to a free-standing metallic material is therefore to be understood herein as that situation where the layer-by-layer build-up is employed to form a given built structure. The parts are then preferably sintered and infiltrated with another material to provide a free-standing part, or just sintered to achieve a porosity of 0% to 55% in the free-standing part (i.e. no infiltration). The final infiltrated structure or sintered (uninfiltrated) structure may then serve as a metallic part component in a variety of applications such as injection molding dies and pump and bearing parts.

The layer-by-layer procedure described herein is preferably selected from binder jetting where a liquid binder is selectively printed on a bed of powder, the binder is dried, a new layer of powder is spread over the prior layer, the binder is selectively printed on the powder and dried, preferably by heating, and this process repeats until the part is fully constructed.

The binder can be any liquid that can be selectively printed through a print head, and when dried acts to bond the powder particles such that additional layers can be subsequently built on top of the present layer, and when dried produces a bond between the particles that enables the part to be handled without damaging the part (“green bond”). The binder also is then preferably burned off in a furnace such that it does not interfere with subsequent sintering of the powder particles in the part. One example of a binder that is suitable for binder jetting is a solution of ethylene glycol monomethyl ether and diethylene glycol. In each layer the binder is dried, after it is printed, with a heating source that heats the powder surface in the range of 30-100° C. When the part is completely built the binder in the part can optionally be heated in an oven at a temperature in the range of 100-300° C., and more preferably in the range of 150-200° C. The time at temperature for curing is in the range of 2-20 hr, and more preferably in the range of 6-10 hr.

The layer-by-layer procedure herein contemplates a build-up of individual layers each having a thickness in the range of 0.005-0.300 mm, and more preferably in the range of 0.070-0.130 mm. The layer-by-layer procedure may then provide for a built up construction with an overall height in the range of 0.010 mm to greater than 100 mm, and more typically greater than 300 mm. Accordingly, a suitable range of thickness for the built-up layers is 0.010 mm and higher. More commonly, however, the thickness ranges are from 0.100-300 mm. The packing of solid particles in the layer-by-layer procedure results in printed and cured parts with an inter-particle porosity in the range of 20-60%, and more particularly in the range of 40-50%.

During powder layer spreading, spherical shaped particles flow more easily than non-spherical shaped particles as they have more freedom to roll and less potential to agglomerate due to irregular shapes catching onto one another. The metal powders used to produce the sintered ferrous skeleton may be a single ferrous alloy or a blend of multiple ferrous alloy powders. The powders have a generally spherical shape and a particle size distribution in the range of 0.005-0.300 mm, and more preferably in the range of 0.010-0.100 mm, and even more preferably in the range of 0.015-0.045 mm.

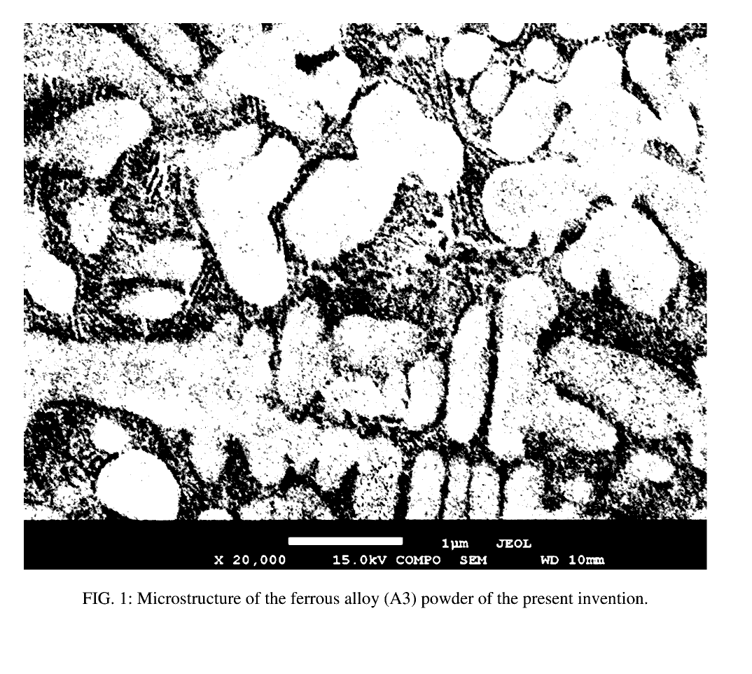

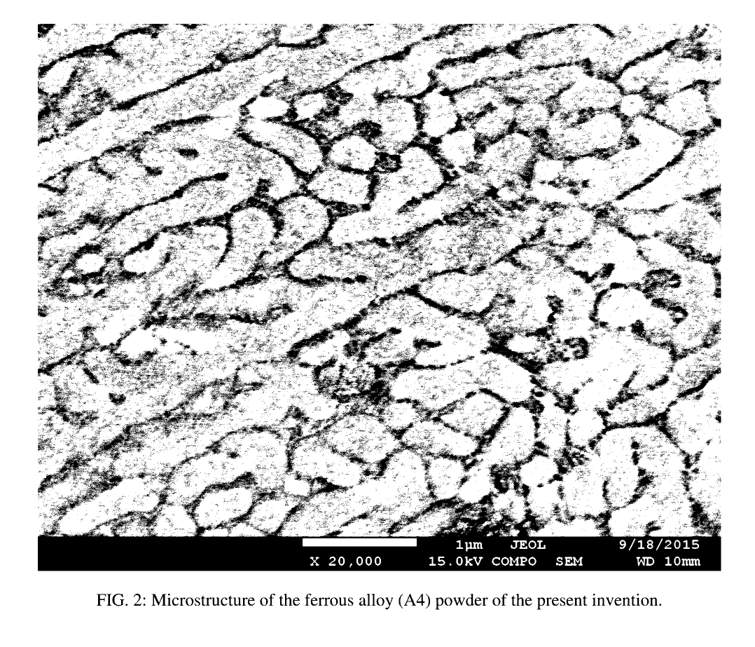

The relatively high hardness of the iron based alloy powders, which are used to produce the steel skeleton, is contemplated to be the result of the relatively fine scale microstructures and phases present in the iron-based alloys when processed in a relatively rapid solidification event such as in liquid phase powder atomization. The iron-based alloys herein are such that when formed into the liquid phase at elevated temperatures and allowed to cool and solidify into powder particles, the structure is contemplated to contain a largely supersaturated solid solution that preferably contains an initial level of distributed secondary boride phases. FIGS. 1 and 2 show SEM images of the powder microstructures in example ferrous alloys A3 and A4. The nanometer-scale dark phase is contemplated to be the initial secondary boride phase, surrounded by the primary steel matrix.

It is worth noting that the above ferrous alloys initially have a relatively low wear resistance. As discussed herein, upon triggering of growth of secondary boride phases in the layer-by-layer procedure one now unexpectedly provides remarkably improved wear resistance properties.

The parts produced with the layer-by-layer procedure are next preferably sintered to increase the part strength by developing metallurgical bonds between the particles. The sintering process is preferably a multistage thermal process conducted in a furnace with a controlled atmosphere to avoid oxidation. The atmosphere may be a vacuum or gas, including an inert gas (e.g. argon, helium, and nitrogen), a reducing gas (e.g. hydrogen), or a mixture of inert and reducing gases. The sintering process stages include binder burn-off, sintering, and cool down and are each preferably defined by a specific temperature and time, as well as a ramp rate between prescribed temperatures. The preferred temperature and time for removal of binder (e.g. binder burn off) depends on the binder and part size, with a typical range of temperatures and times for burn off between 300° C. and 800° C. and 30 min to 240 min. Sintering is performed at a temperature and time sufficient to cause metallurgical bonds to form, while also minimizing part shrinkage. Sintering is preferably performed in a temperature range of 800-1200° C., and more preferably in the range of 950-1100° C. The sintering time that the entire part is at the sintering temperature is preferably in the range of 1-720 min, and more preferably in the range of 90-180 min for parts that are to be subsequently infiltrated. Sintering of parts that are to be subsequently infiltrated results in a reduction of porosity in the range of 0.1-5% from the cured binder state which has an initial porosity in the range of 20-60%. Accordingly these sintered parts may have a porosity in the range of 15-59.1%, which sintered parts are then exposed to an infiltration process, as disclosed herein, to provide the free-standing part

Sintering of parts that will not be subsequently infiltrated preferably results in a reduction of porosity in the range of greater than 5% to 60% from the cured binder state which has an initial porosity in the range of 20% to 60%. Accordingly, the sintering in this case leads to a part with a final porosity in the range of 0% to 55%.

Infiltration of sintered parts produced with the layer-by-layer procedure may be conducted when the parts are either cooled following sintering then reheated in a furnace and infiltrated with another material, or infiltration with another material may follow sintering as an additional step within the sintering furnace cycle. In the infiltration process, the infiltrant, in a liquid phase, is drawn into the part, such as via capillary action, to fill the voids of the steel skeleton. The infiltrating temperature is preferably at least 10° C. above the liquidus temperature of the infiltrant, and more preferably at least 40° C. above the liquidus temperature of the infiltrant. The infiltrating time is preferably in the range of 30-1000 min depending on the part size and complexity. For very large parts the time could be greater than 1000 min. The final volume ratio of infiltrant to steel skeleton is preferably in the range of 15/85 to 60/40. Following infiltration the infiltrant is solidified by reducing the furnace temperature below the solidus temperature of the infiltrant. Residual porosity following infiltration is preferably in the range of 0-20%, and more preferably in the range of 0-5%. The furnace and parts are then cooled to room temperature. Unlike hardenable steel alloys, the steel alloys of the present invention have a relatively low dependency on cooling rate, and as such can be cooled at a relatively slow rate to reduce the potential for distortion, cracking, and residual stresses during cooling, yet maintain high hardness and wear resistance. Cooling rates of less than 6° C./min, and more particularly less than 2° C./min, can be used to reduce distortion, cracking, and residual stresses. Cooling rates between 1° C./min and 6° C./min are preferred.

The alloys for use as the metallic alloy particles, which are then mixed with binder, include those alloys that provide an initial level of a boride phase which can be increased by the additive manufacturing procedures, such as the heating provided by the sintering and/or infiltration steps herein. The alloys therefore comprise Fe based alloys that contain a sufficient amount of B along with other elements that do not interfere with the ability for the increase in boride phase growth in the additive manufacturing process. Accordingly, the alloys herein preferably contain Fe and B, and one or more elements selected from Cr, Ni, Si and Mn, and optionally C.

In one particular preferred alloy formulation, the alloy contains Fe, B, Cr, Ni, and Si. In another particularly preferred alloy composition, the alloy contains Fe, B, Cr, Ni, Si, and Mn. Carbon is again optionally present to either of these preferred compositions. The preferred levels of the alloy elements are contemplated to be, in weight percent, Cr (15.0-22.0), Ni (5.0-15.0), Mn (0-3.5), Si (2.0-5.0), C (0-1.5), B (0.5-3.0), the balance Fe (77.5-50.0). Consistent with this description, alloy composition A3 herein has the following general composition, in weight percent: Cr (15.0-20.0); Ni (11.0-15.0); Si (2.0-5.0); C (0-1.5); B (0.5-3.0), balance Fe (71.5-55.5), and alloy A4 herein has the following general composition, in weight percent: Cr (17.0-22.0); Ni (5.0-10.0); Mn (0.3-3.0), Si (2.0-5.0); C (0-1.5); B (0.5-3.0), balance Fe (75.2-55.5).

In yet a further preferred embodiment, the alloy herein contains Fe, B, Cr, Ni and Si and is contemplated to have the following composition in weight percent: Cr (15.0-20.0); Ni (11.0-15.0); Si (0.5-2.0); C (0-1.5) and B (0.5-3.0) and Fe (60.0-73.0). Consistent with this description, alloy composition A7 was formed and evaluated herein had the following composition in weight percent: Cr (15.5-17.5); Ni (13.5-15.0); Si (0.9-1.1); C (0-1.5); B (1.0-1.3) and Fe (63.6-70.0). As can be appreciated, in this preferred alloy, both C and Mn are optional and the alloy can be prepared such that it does not contain these elements.

A variety of metal alloys may be used as infiltrants. One preferred criteria for the infiltrant are that it has a liquidus temperature below that of the sintered skeleton and it preferably wets the surface of the sintered skeleton. The primary issues that can be encountered and are preferably minimized with infiltration include residual porosity, material reactions, and residual stresses. Residual porosity is typically due to one or more of: poor wettability between the sintered skeleton and infiltrant, insufficient time for complete infiltration, or insufficient infiltration temperature resulting in a high viscosity of the infiltrant. Material reactions can occur between the sintered skeleton and the infiltrant such as dissolution erosion of the sintered skeleton and intermetallic formation. Residual stresses can also develop due to mismatched material properties.

An example of a preferred infiltrant for infiltrating the steel skeleton of the present invention is bronze. Bronze is a preferred infiltrant with the steel skeleton because (1) copper wets the iron in the steel very well, (2) the tin in bronze depresses the liquidus temperature below that of copper enabling superheating of the bronze to reduce the viscosity while still being at a low temperature, and (3) both Cu and Sn have low solubility in Fe at the superheat temperature. At 1083° C. the solubilities of Cu in Fe, Fe in Cu, Sn in Fe, and Fe in Sn are only 3.2, 7.5, 8.4, and 9.0 atomic percent, respectively. Various bronze alloys may be used including Cu10Sn.

In situ with the sintering and infiltrating processes at high temperatures, greater than or equal to 800° C., the secondary boride phases of the ferrous alloys of the present invention are contemplated to grow through diffusion from the initial secondary boride phases present in the powders, and/or precipitate out of the solid solution then grow through diffusion. The boride phases may contain boron along with chromium, silicon, iron, and oxygen and they may also contain carbon. The boride phases are contemplated to have a relatively high hardness and enable the high wear resistance properties of the material. Without being bond by the following, the growth of the secondary boride phases is contemplated to be a result of elements diffusing from the matrix to increase the amount of the boride phases, a process that depletes the matrix of the elements that make up the boride phase, which is observed to result in increasing the ductility and toughness of the final part produced by additive manufacturing.

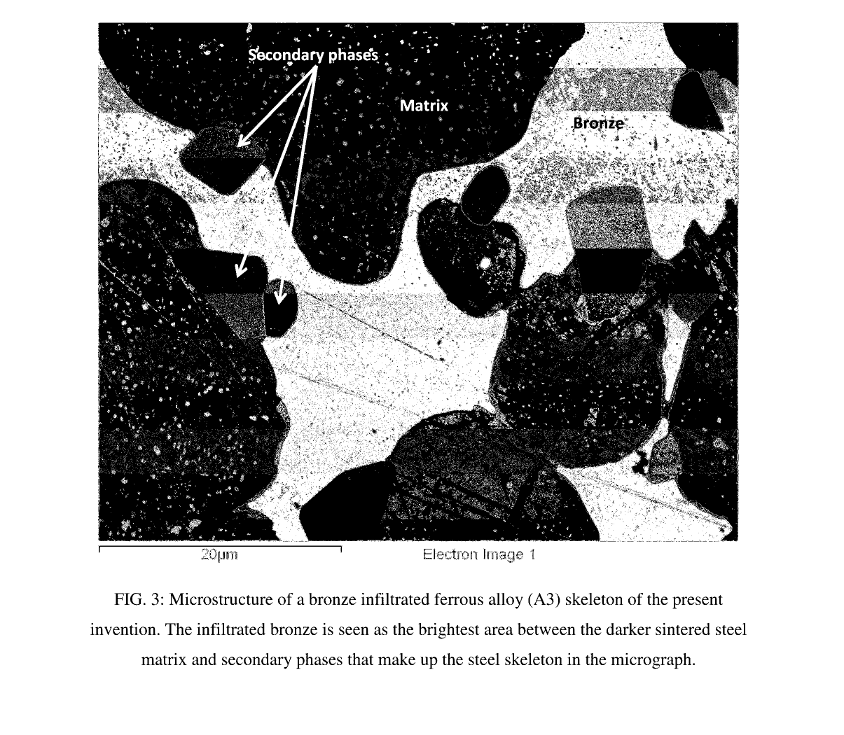

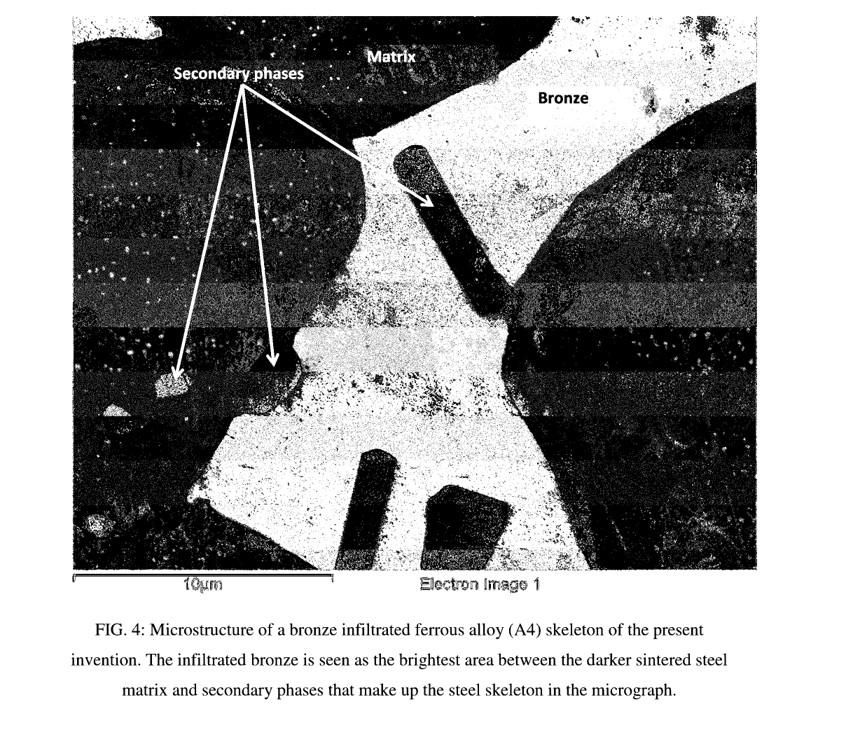

FIG. 3 shows a scanning electron microscopy (SEM) image at 2,500× magnification of the exemplary ferrous alloy A3 shown in FIG. 1 in powder form, now having been binder jet, sintered, and infiltrated with bronze. FIG. 4 shows a SEM image at 5,000× magnification of the exemplary ferrous alloy A4 shown in FIG. 2 in powder form, now having been binder jet, sintered, and infiltrated with bronze. It can be seen that the bronze is effective in filling the voids between members of the steel skeleton and that the steel skeleton now contains relatively large secondary phases.

FIGS. 3 and 4 show elemental maps, produced with energy dispersive spectroscopy (EDS), of the exemplary binder jet, sintered, and bronze infiltrated alloys A3-Cu10Sn and A4-Cu10Sn, respectively. The elemental map clearly shows the higher percentage of elements present in each phase by the pixel brightness, where the grayscale value for a given pixel in the digital map corresponds to the number of X-rays which enter the X-ray detector to show the distribution of the elements. SEM and EDS analysis were performed on a Jeol JSM-7001F Field Emission SEM and Oxford Inca EDS System. SEM images were taken in backscatter mode and EDS was performed with an accelerating voltage of 4 keV, probe current of 14 μA, and livetime of 240 s. The elemental maps of FIGS. 3 and 4 show a high concentration of boron, chromium, and oxygen in the secondary phases. The ductile steel matrix is shown to be enriched in Fe, Si, and Cr. The Cu in the infiltrant and Fe in the steel matrix can be seen to have a very low diffusivity and solubility, as there is a very low concentration of Fe seen in the infiltrant region and Cu in the steel skeleton region.

While the composite structure of an infiltrated material gains its bulk properties from a combination of the skeleton material and infiltrant, the wear resistance is contemplated to be largely provided by the skeleton in the structure. Hardness is commonly used as a proxy for wear resistance of a material; however, it is not necessarily a good indicator in composite materials such as a bronze infiltrated steel skeleton. The high load and depth of penetration of macrohardness measurements results in a measurement of the composite material, i.e. a blended mix of the hardnesses of both components, whereas microhardness measurements can be made individually in the infiltrant and in the skeleton areas. The macrohardness of the bulk composite material and the microhardness of the infiltrant and skeleton materials in the bulk composite material for various infiltrated ferrous alloys are shown in Table 1.

TABLE 1
Hardness and Wear Resistance of Bronze Infiltrated Ferrous Alloys

| Material | | | | | |
|---|---|---|---|---|---|
| System | | | | Volume Loss in Wear | Impact |
| (Skeleton- | | Microhardness [HV] | | [mm³] | toughness |
| Infiltrant) | Macrohardness | Skeleton | Infiltrant | (ASTM G65-A (2010) ) | [J] |
| S42000- | 21 HRC | 524 | 117 | 366/475¹ | 27.9 |
| Cu10Sn | | | | | |
| A3-Cu10Sn | 86 HRB | 228 | 135 | 100 | 75.0 |
| A4-Cu10Sn | 88 HRB | 276 | 159 | 109 | 62.4 |
| A7-Cu10Sn | 83 HRB | 175 | — | 198¹ | 74.6 |

¹These data points were pursuant to ASTM G65-10 Procedure A (2016).

Unless otherwise noted, the wear resistance, as measured by ASTM G65-10 Procedure A (2010), and the un-notched impact toughness, as measured by ASTM E23-12 (2012), of these materials is also shown in Table 1. The S42000 alloy has the following composition in weight percent: 12<Cr<14; Mn<1.0; Si<1.0; C≧0.15, balance Fe. As can be seen, in general, the wear resistance of the alloys herein as measured by ASTM G65-10 Procedure A in general indicates a volume loss of less than or equal to 200 mm³, and preferably in the range of 100 mm³ to 200 mm³ or in the range of 75 mm³ to 200 mm³. More preferably, with respect to alloys A3 and A4, the wear resistance is less than or equal to 150 mm³ and in the range of 100 mm³ to 150 mm³. Impact toughness as measured by ASTM E23-12 falls in the range of 55 J to 100 J, more preferably in the range of 55 J to 75 J.

While the macrohardness of the bulk material and the microhardness of the steel skeleton in S42000 is significantly larger than the hardness values of the ferrous alloys of the present invention, the wear resistance is quite different. The difference in wear resistance between the ferrous alloys of the present invention and S42000 is contemplated to be the result of the non-optimal hardening conditions of S42000, and the ability to increase the volume fraction of the boride phases initially present in the steel skeleton prior to heat treatment during sintering and/or infiltration. It is important to note that the non-optimal hardening of the bronze infiltrated S42000 is an inherent process limitation due to the insufficient cooling rate of the infiltration process to fully transform the austenite in the structure to martensite. Table 1 shows that the steel skeletons in the ferrous alloys of the present invention have a low microhardness, but a wear resistance that is approximately 3× greater than the S42000, although S42000 has about 2× higher microhardness. The low microhardness measurements in the ferrous alloys of the present invention are contemplated to be the result of the microhardness measurements containing measurements from both the softer matrix and the harder secondary phases. The high wear resistance is contemplated to be due to the increase in the boride phases by heating during sintering and/or infiltration. The relatively soft and ductile steel matrix is contemplated to provide greater than 2× the impact toughness of bronze infiltrated S42000.

Many hardenable metals have a relatively low maximum operating temperature capability above which the materials soften or embrittle due to phase transformations. For example, the maximum operating temperature for a stable structure of a S42000 is 500° C. In the present invention the high temperature stability of the steel skeleton in the infiltrated parts is contemplated to enable high operating temperatures up to 1000° C.

The thermal properties of infiltrated ferrous alloys are compelling for steel requiring fast thermal cycling such as injection molding dies. The thermal conductivity in bronze infiltrated ferrous alloys is contemplated to be much higher than typical injection molding steels such as the P20 grade due to the nearly order of magnitude higher thermal conductivity of bronze over ferrous alloys. The high thermal conductivity of infiltrated ferrous alloy dies enables high heating and cooling rates through the material. Infiltrated steel parts of the present invention are contemplated to have a low thermal expansion due to the low thermal expansion of the steel skeleton which facilitates dimensional control in applications that require thermal cycling such as injection mold dies. While both the high thermal conductivity, and the low thermal expansion, of the infiltrated ferrous alloys of the present invention result in increased material performance in applications requiring high thermal cycling, the combination of these properties is contemplated to result in materials that offer high productivity and high dimensional control, a combination that is unexpected since as one of these attributes is increased it is normally at the expense of the other.

1. A method for layer-by-layer formation of a free-standing metallic part comprising:
(a) supplying metal alloy particles comprising at least 50 weight % Fe and at least 0.5 weight % B and one or more elements selected from Cr, Ni, Si and Mn, wherein said particles have an initial level of boride phases;
(b) mixing said metallic alloy particles with a binder wherein said binder bonds said particles and forms a layer of said free-standing metallic part wherein said layer has a porosity in the range of 20% to 60%;
(c) heating said metallic alloy particles and said binder and forming a bond between said particles;
(d) sintering said metallic alloy particles and said binder by heating at a temperature of greater than or equal to 800° C. and removing said binder and forming a porous metallic skeleton;
(e) infiltrating said porous metallic skeleton with an infiltrant at a temperature of greater than or equal to 800° C. and cooling and forming said free-standing metallic part, wherein during said step of sintering and/or infiltrating, increasing the level of boride phases;
wherein said free-standing metallic part indicates a volume loss of less than or equal to 200 mm³ as measured according to ASTM G65-10 Procedure A (2010) and an un-notched impact toughness of greater than or equal to 55 J according to ASTM E23-12 (2012).

2. The method of claim 1 wherein said one or more elements selected from Cr, Ni, Si and Mn comprises Cr, Ni and Si.

3. The method of claim 1 wherein said one or more elements selected from Cr, Ni, Si and Mn comprise Cr, Ni, B, Si and Mn.

4. The method of claim 1 wherein said alloy comprises Cr at 15.0-22.0 wt. %, Ni at 5.0-15.0 wt. %, Mn at 0-3.5 wt. %, Si at 2.0-5.0 wt. %, C at 0-1.5 wt. %, B at 0.5-3.0 wt. % and Fe at 77.5-50.0 wt. %.

5. The method of claim 1 wherein said alloy comprises Cr at 15.0-20.0 wt. %, Ni at 11.0-15.0 wt. %, Si at 2.0-5.0 wt. %, C at 0-1.5 wt. %, B at 0.5-3.0 wt. % and Fe at 71.5-55.5 wt. %.

6. The method of claim 1 wherein said alloy comprises Cr at 17.0-22.0 wt. %, Ni at 5.0-10.0 wt. %, Mn at 0.3-3.0 wt. %, Si at 2.0-5.0 wt. %, C at 0-1.5 wt. %, B at 0.5-3.0 wt. % and Fe at 55.5-75.2 wt. %.

7. The method of claim 1 wherein said alloy comprises Cr at 15.0-22.0 wt. %, Ni at 5.0-15.0 wt. %, Mn at 0-3.5 wt. %, Si at 2.0-5.0 wt. %, C at 0-1.5 wt. %, B at 0.5-3.0 wt. %, and Fe at 77.5-50.0 wt. %.

8. The method of claim 1 wherein said alloy comprises Cr at 15.0-20.0 wt. %, Ni at 11.0-15.0 wt. %, Si at 0.5-2.0 wt. %; C at 0-1.5 wt. %, B at 0.5-3.0 wt. 5 and Fe at 60.0-73.0 wt. %.

9. The method of claim 1 wherein said metal particles have a particle size distribution in the range of 0.005-0.300 mm.

10. The method of claim 1 wherein said layer has a thickness in the range of 0.005 to 0.300 mm.

11. The method of claim 1 wherein steps (b) through (d) are repeated to provide a layer-by-layer build up with an overall thickness in the range of 0.010 mm to 300 mm.

12. The method of claim 1 wherein said sintering provides a metallic skeleton having a porosity of 15% to 59.1%.

13. The method of claim 1 wherein said infiltrating of said porous metallic skeleton is configured to provide a final volume ratio of infiltrant to skeleton in the range of 15/85 to 60/40.

14. The method of claim 1 wherein said free-standing metallic part indicates a volume loss in the range of 75 mm³ to 200 mm³.

15. The method of claim 1 wherein said free-standing metallic part indicates an an un-notched impact toughness in the range of 55 J to 100 J.

16. A method for layer-by-layer formation of a free-standing metallic part comprising:
(a) supplying metal alloy particles comprising at least 50 weight % Fe and at least 0.5 weight % B and one or more elements selected from Cr, Ni, Si and Mn, wherein said particles have an initial level of boride phases;
(b) mixing said metallic alloy particles with a binder wherein said binder bonds said particles and forms a layer of said free-standing metallic part wherein said layer has a porosity in the range of 20% to 60%;
(c) heating said metallic alloy particles and said binder and forming a bond between said particles;
(d) sintering said metallic alloy particles and said binder by heating at a temperature of greater than or equal to 800° C. and removing said binder and forming a porous metallic skeleton having a porosity of 0% to 55%, wherein during said step of sintering, increasing the level of boride phases.

17. The method of claim 16 wherein said alloy comprises Cr at 15.0-22.0 wt. %, Ni at 5.0-15.0 wt. %, Mn at 0-3.5 wt. %, Si at 2.0-5.0 wt. %, C at 0-1.5 wt. %, B at 0.5-3.0 wt. % and Fe at 77.5-50.0 wt. %.

18. The method of claim 16 wherein said alloy comprises Cr at 15.0-20.0 wt. %, Ni at 11.0-15.0 wt. %, Si at 2.0-5.0 wt. %, C at 0-1.5 wt. %, B at 0.5-3.0 wt. % and Fe at 71.5-55.5 wt. %.

19. The method of claim 16 wherein said alloy comprises Cr at 17.0-22.0 wt. %, Ni at 5.0-10.0 wt. %, Mn at 0.3-3.0 wt. %, Si at 2.0-5.0 wt. %, C at 0-1.5 wt. %, B at 0.5-3.0 wt. % and Fe at 55.5-75.2 wt. %.

20. The method of claim 16 wherein said alloy comprises Cr at 15.0-22.0 wt. %, Ni at 5.0-15.0 wt. %, Mn at 0-3.5 wt. %, Si at 2.0-5.0 wt. %, C at 0-1.5 wt. %, B at 0.5-3.0 wt. %, and Fe at 77.5-50.0 wt. %.

21. The method of claim 16 wherein said alloy comprises Cr at 15.0-20.0 wt. %, Ni at 11.0-15.0 wt. %, Si at 0.5-2.0 wt. %; C at 0-1.5 wt. %, B at 0.5-3.0 wt. 5 and Fe at 60.0-73.0 wt. %.
